(19) United States
(12) Patent Application Publication
(10) Pub. No.: US 2016/0063335 A1
(43) Pub. Date: Mar. 3, 2016

(54) A METHOD AND TECHNICAL EQUIPMENT FOR PEOPLE IDENTIFICATION

(71) Applicant: NOKIA TECHNOLOGIES OY, Espoo (FI)

(72) Inventors: Kongqiao Wang, Beijing (CN); Jiangwei Li, Beijing (CN); Lei Xu, Beijing (CN); Jyri Huopaniemi, Espoo (FI)

(21) Appl. No.: 14/783,977

(22) PCT Filed: May 3, 2013
(86) PCT No.: PCT/CN2013/075153

§ 371 Date: Oct. 12, 2015

(51) Int. Cl. G06K 9/00

(52) U.S. Cl. CPC G06K 9/00892; G06K 9/00765

(57) ABSTRACT

A method and a technical equipment for people identification. The method comprises detecting a person segment in video frames; extracting feature vector sets for several feature categories from the person segment; generating a person feature model of the extracted feature vectors sets; and transmitting the person feature model to a people identification model pool. The solution can provide more extensive people identification.

### TECHNICAL FIELD

The present application relates generally to a video-based model creation. In particular the present application relates to people identification from a video-based model.

### BACKGROUND

Social media has increased the need for people identification. Social media users upload images and videos to their social media account and tags persons appearing in the images and videos. This may be done manually, but also automatic people identification methods have been developed.

People identification may be based on still images, where—for example—face of a person is computed to find out certain characteristics for the face. While some known people identification methods rely on face recognition, some of them are targeted to face model updating solution for improving the face recognition accuracy. Since these methods are based on face detectability, it is understood that if a face is not visible, the person cannot be identified. Some known people identification methods utilizes the fusion of gait identification with face recognition. There are two kinds of solutions for performing that—some of them use gait identification for candidate selection, and face recognition for final identification, some of them fuse the features of gait and face for a combinative model training. In such solutions, equally approaching gait features and face features is unreasonable.

There is, therefore, a need for a solution for more extensive people identification.

### SUMMARY

Now there has been invented an improved method and technical equipment implementing the method, by which the above problems are alleviated.

According to a first aspect, a method, comprises detecting a person segment in video frames; extracting feature vector sets for several feature categories from the person segment; generating a person feature model of the extracted feature vectors sets; and transmitting the person feature model to a people identification model pool.

According to an embodiment, several feature categories relate to any combination of the following: face features, gait features, voice features, hand features, body features.

According to an embodiment, face feature vectors are extracted by locating a face from the person segment and estimating face's posture.

According to an embodiment, gait feature vectors are extracted from a gait description map, that is generated by combining normalized silhouettes, which silhouettes are segmented from each frame of the person segment containing a full body of the person.

According to an embodiment, voice feature vector is determined by detecting person segment including person's close-up and detecting whether the person is speaking, and if so, the voice is extracted to determine the voice feature vector.

According to an embodiment, the person feature model is used to find a corresponding person feature model in the people identification model pool.

According to an embodiment, if a corresponding person feature model is not found, a new person feature model is created to the people identification model pool.

According to an embodiment, if a corresponding person feature model is found, the corresponding person feature model is updated by the transmitted person feature model.

According to an embodiment, the person feature model is used to find an associating person feature model.

According to an embodiment, the associating person feature model is found by determining either location information or time information or both of the person feature model and by finding an associating person feature model that matches with at least one of the information.

According to an embodiment, the person feature model is merged with the associating person feature model, if the models belong to the same person.

According to a second aspect, an apparatus comprises at least one processor, memory including computer program code, the memory and the computer program code configured to, with the at least one processor, cause the apparatus to perform at least the following: detecting a person segment in video frames; extracting feature vector sets for several feature categories from the person segment; generating a person feature model of the extracted feature vectors sets; and transmitting the person feature model to a people identification model pool.

According to a third aspect, an apparatus comprises means for detecting a person segment in video frames; means for extracting feature vector sets for several feature categories from the person segment; means for generating a person feature model of the extracted feature vectors sets; and means for transmitting the person feature model to a people identification model pool.

According to a fourth aspect, a system comprises at least one processor, memory including computer program code, the memory and the computer program code configured to, with the at least one processor, cause the system to perform at least the following: detecting a person segment in video frames; extracting feature vector sets for several feature categories from the person segment; generating a person feature model of the extracted feature vectors sets; and transmitting the person feature model to a people identification model pool.

According to a fifth aspect, a computer program product embodied on a non-transitory computer readable medium, comprising computer program code configured to, when executed on at least one processor, cause an apparatus or a system to: detect a person segment in video frames; extract feature vector sets for several feature categories from the person segment; generate a person feature model of the extracted feature vectors sets; and transmit the person feature model to a people identification model pool.

### DESCRIPTION OF THE DRAWINGS

In the following, various embodiments of the invention will be described in more detail with reference to the appended drawings, in which

FIG. 1 shows a simplified block chart of an apparatus according to an embodiment;

FIG. 2 shows a layout of an apparatus according to an embodiment;

FIG. 3 shows a system configuration according to an embodiment; FIG. 4 shows an example of person extraction from video frames;

FIG. 5 shows an example of human body detection in video frames;

FIG. 6 shows an example of various feature vectors extracted from video frames;

FIG. 7 shows an identification model creating/updating method according to an embodiment;

FIG. 8 shows an example of a situation for identification model creating; and

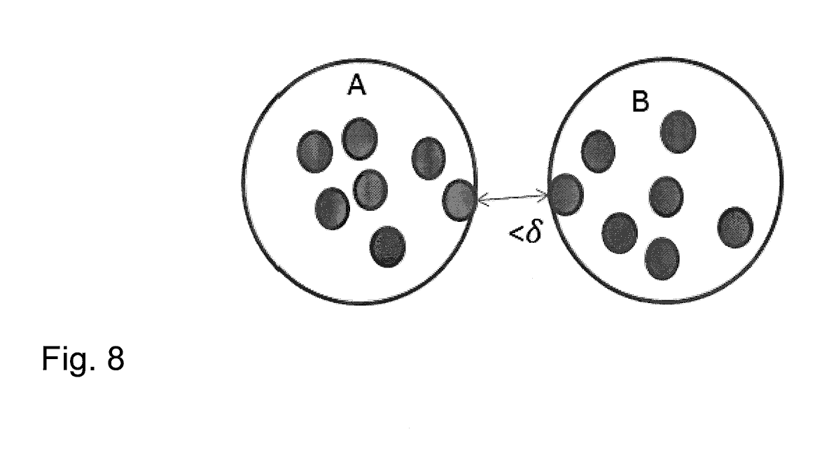

FIG. 9 shows an example of a situation for identification module updating.

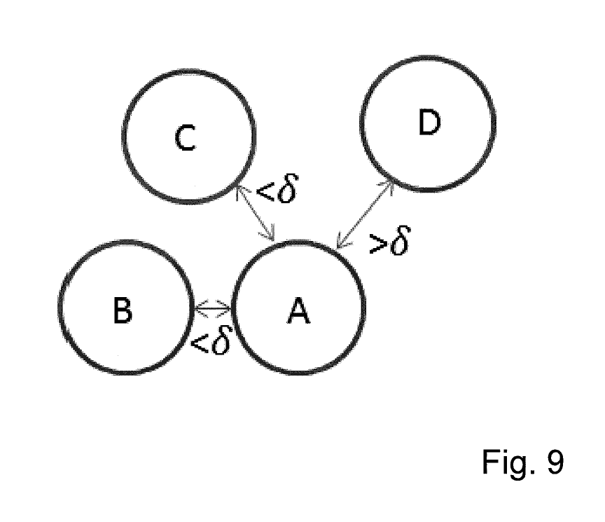

### DESCRIPTION OF EXAMPLE EMBODIMENTS

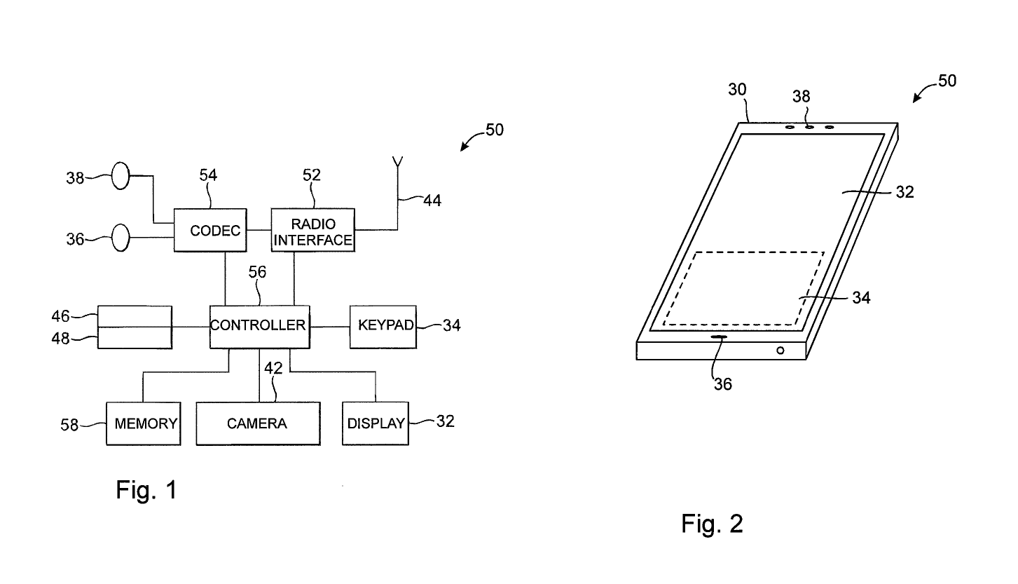

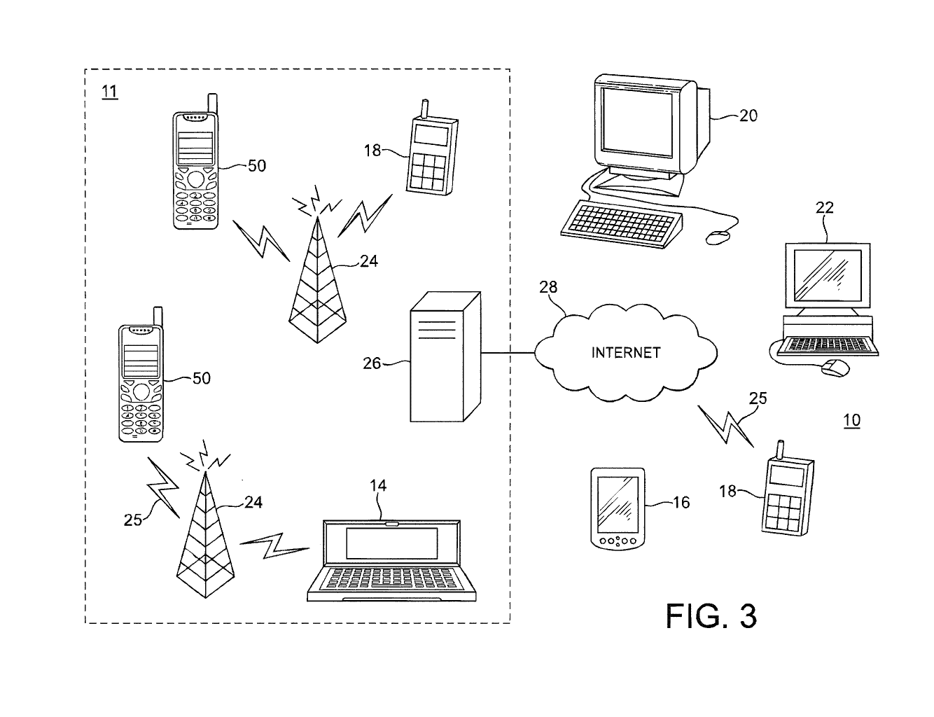

In the following, a multi-dimensional people identification method is disclosed, which utilizes face recognition, gait recognition, voice recognition, gestures recognition, etc. in combination to create new models and updating existing models in the people identification model pool. Also, the embodiments proposes computing models' association property based on their model feature distances together with the location and time information so as to facilitate the manual model correction in the model pool. The image frames to be utilized in the multi-dimensional people identification method, can be captured by an electronic apparatus, example of which is illustrated in FIGS. 1 and 2.

The apparatus or electronic device 50 may for example be a mobile terminal or user equipment of a wireless communication system. However, it would be appreciated that embodiments of the invention may be implemented within any electronic device or apparatus which are able to capture image data, either still or video images. The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise a camera 42 capable of recording or capturing images and/or video or may be connected to one. In some embodiments the apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In some embodiments of the invention, the apparatus may receive the video image data for processing from another device prior to transmission and/or storage. In some embodiments of the invention, the apparatus 50 may receive either wirelessly or by a wired connection the image for processing.

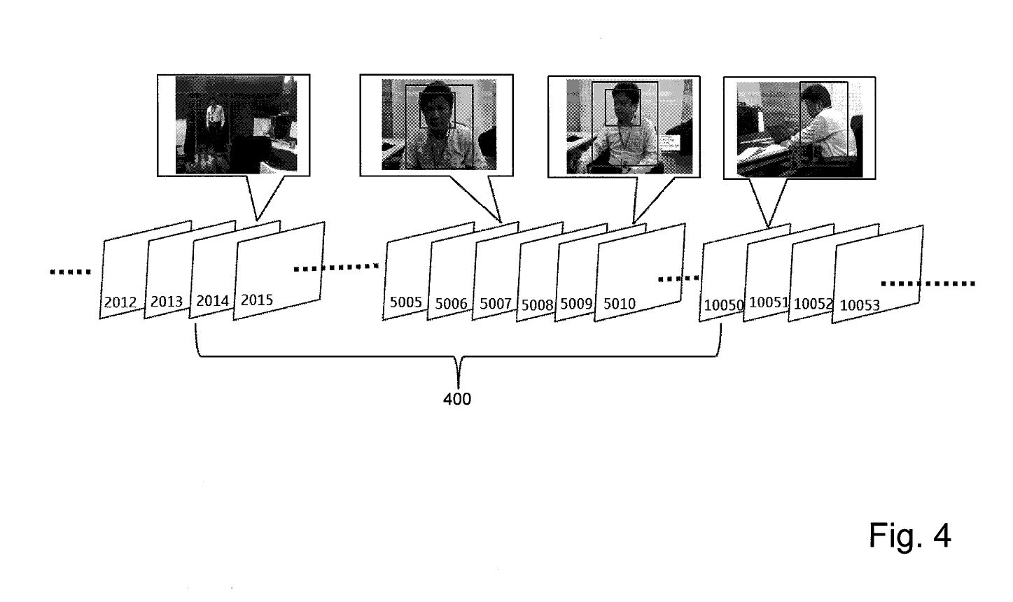

FIG. 3 shows a system configuration comprising a plurality of apparatuses, networks and network elements according to an example embodiment. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention. For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatuses may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

The embodiments of the present invention uses face detection and tracking technology together with human body detection technology across video frames to segment people's presentation in the video. FIG. 4 illustrates hybrid person tracking technology which combines human body detection and face tracking to extract person's presentation across the video frames. A video segment that contains a continuous presentation of a certain person is called a person segment. In the same video, different person segments can have overlapping as two or more people present in the same video frames at the same time. In FIG. 4, a reference number 400 indicates the person presentation in video, i.e. in frames 2014-10050. Person extraction from these video frames takes advantage of face tracking and human body detection technologies. The same person can be confirmed based on the hybrid person tracking (that combines human body tracking and face tracking) from the frame that the person at first appears in the video to the frame that the person disappears from the video. This kind of a frame segment is called “person segment”.

For each person segment, several categories of feature vectors are extracted to represent the person's features, for example face feature vectors, gait feature vectors, voice feature vectors and hand/body gesture feature vectors, etc.

The first category of feature vectors is facial feature vectors (FFV1, FFV2, FFV3, . . . ). In a person segment, the face detection and tracking is used to locate person's face in each frame. Once a face can be located, face's posture is estimated. Based on different facial postures, corresponding face feature vectors can be extracted for the face.

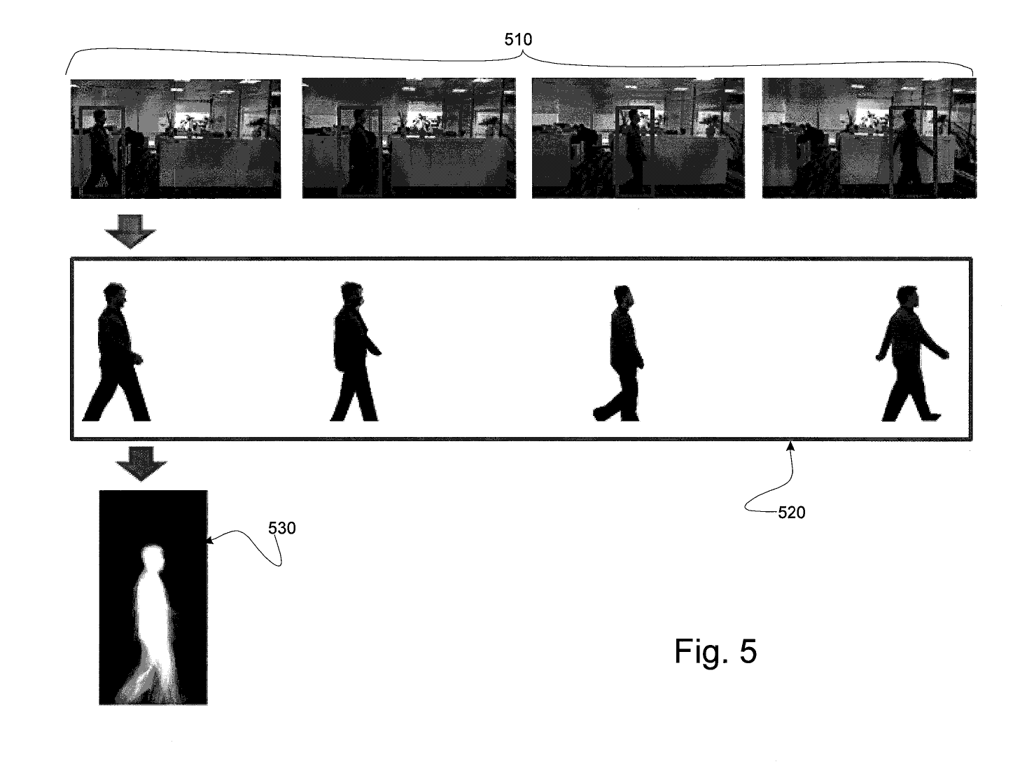

The second category of feature vectors is gait feature vectors (GFV1, GFV2, GFV3, . . . ). In a person segment, full human body detection and tracking methods are used to find which continuous frames in the segment include the full body of the person. After this, the silhouette of the person's body is segmented from each frame in which the full body of the person is detected. In order to build a gait feature vector for the person, each silhouette of the person is normalized and these normalized silhouettes are then combined together to get a feature vector description map for the person from the continuous frames in the person's segment. FIG. 5 illustrates full human body detection from video frames 510. A gait description map 520 is created based on this full human body detection. The gait description map 520 is used to extract the corresponding gait feature vector 530 to present the person's gait while s/he walks across the video frames.

The third category of feature vectors can be voice feature vectors (VFV1, VFV2, VFV3, . . . ). In a person segment, an upper-part human body detection and face tracking methods are used to find which continuous frames in the segment include the person's close-up. If the person is speaking during this period, his/her voice will be extracted to build voice feature vector. The frame period having the close-up is selected in order to efficiently avoid background noise to be regarded as the person's voice by mistake.

A people identification model pool being utilized by the embodiments, may be located at a server (for example in a cloud). It is appreciated that a small scale people identification pool may also be located on an apparatus. In the people identification model pool, a person is represented with the corresponding feature vector set (i.e. feature model) PM(i)={{FFV1 . . . n1}{GFV1 . . . n2}{VFV1 . . . n3}}(i=1, 2, . . . n) where n1, n2, n3 are the number of feature vectors representing the person's face, gait and voice respectively, PM means person model and ii refers to the number of people being registered in the identification model pool. In the feature vector set, other features, e.g. gestures, could also be included, but they are ignored in this description for simplicity.

If a person's feature vector set {{ffv1 . . . t1}{gfv1 . . . t2}{vfv1 . . . t3}} can be obtained from a person segment being extracted from a video, the vector set can be then set into the identification model pool for creating a new person model PM(n+1)={{FFV1 . . . n1}{GFV1 . . . n2}{VFV1 . . . n3}} in the identification model pool for the person if the person does not have registration there. The pool will then have n+1 people registered in the model pool.

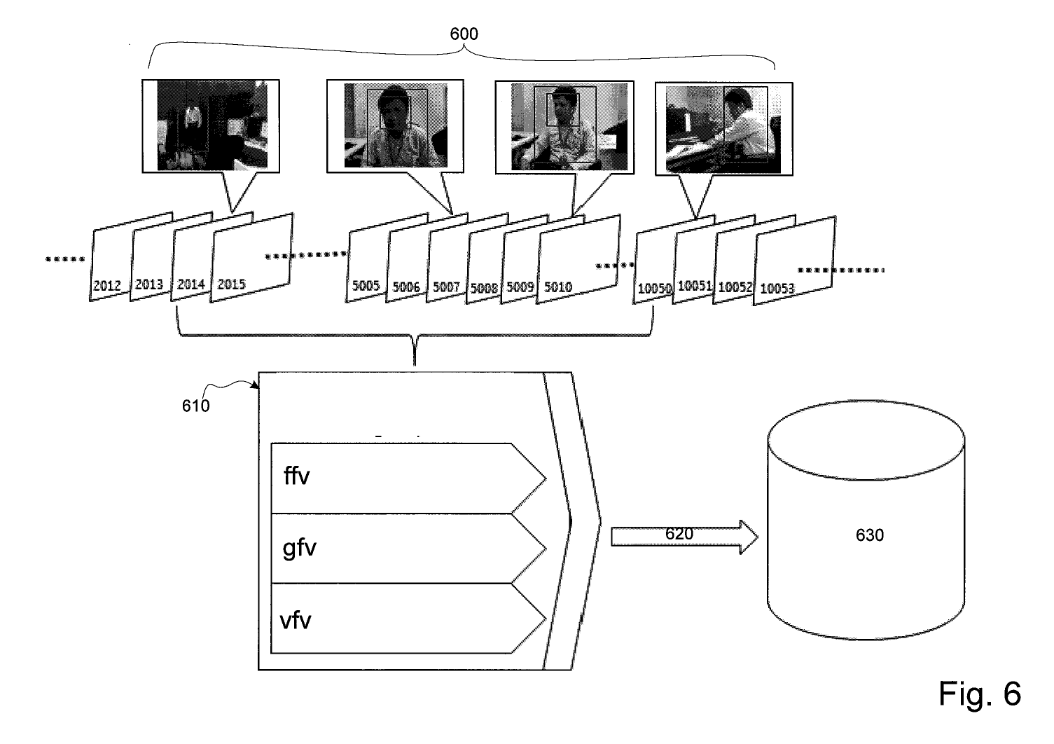

If, however, the person has a registration in the model pool beforehand, the identification model pool is updated with the vector set {{ffv1 . . . t1}{gfv1 . . . t2}{vfv1 . . . t3}}. The pool then sill has n people registered, but the corresponding person registered in the pool is updated with the input feature vector set. FIG. 6 illustrates various feature vectors 610, where ffv stands for face feature vectors, gfv stands for gait feature vectors and vfv stands for voice feature vectors. The feature vectors 610 are extracted from the person segment in the video 600. The person's feature vectors are transmitted 620 into the people identification model pool 630. In the people identification model pool 630 a new recognition model set for the person is created if the person does not have a registration in the identification model pool, or the recognition model set is updated for the person if the person already has a registration in the recognition system.

As said, the person identification model pool 630 contains n people registered. Each person in the pool has a corresponding feature vector set or feature model PM(i)={{FFV(i, 1 . . . n1)}{GFV(i, 1 . . . n2)}{VFV(i, 1 . . . n3)}}(i=1, 2, . . . n) where n1, n2, n3 are the number of feature vectors representing the person's face, gait and voice respectively and {FFV(i, 1 . . . n1)}, {GFV(i, 1 . . . n2)})} and {VFV(i, 1 . . . n3)} correspond to {FFV(i, 1), FFV(i, 2), . . . FFV(i, n1)}, {GFV(i, 1), GFV(i, 2), GFV(i, n2)}, {VFV(i, 1), VFV(i, 2), . . . VFV(i, n3)} respectively.

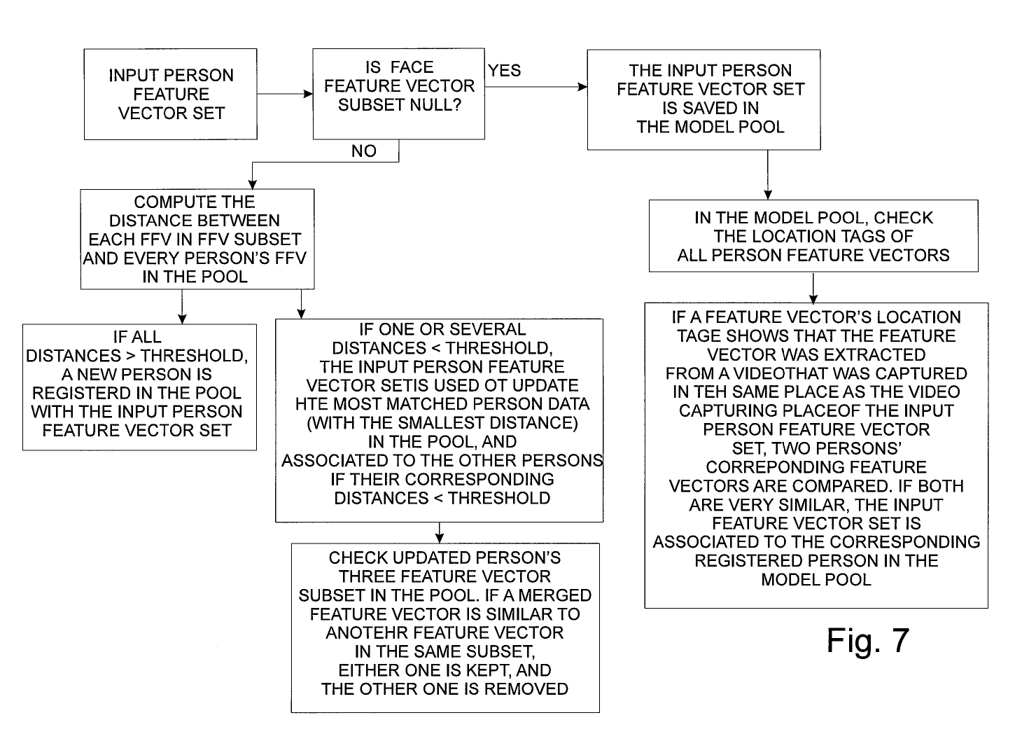

FIG. 7 illustrates an embodiment of the identification model creation/update method diagram with a person feature vector set extracted from an input video for the identification model pool.

Creation of Person Feature Vectors from the Person Segment

By using hybrid people tracking method including body detection and face tracking for a video, person's presentation in a video can be detected from the first frame where the person appears till the last frame where s/he disappears from the video. As discussed earlier, that period where the person can be viewed is called “a person segment”. The person may appear in each frame of the person segment according to one of the following conditions:
a) full body can be detected, but face cannot be detected within the body region;
b) full body can be detected and face can also be detected within the body region;
c) upper-part human body can be detected, but face cannot be detected within the body region;
d) upper-part human body can be detected and face can also be detected within the body region;
e) only face is detected (in this case, the most part of the frame includes the face, i.e. it is a close-up).

A face feature vector for the person can be created for conditions b), d) and e) condition. For each frame in which the person's face can be detected, a face feature vector can be built for the person from the frame, after needed pre-processing steps (e.g. eyes localization, face normalization, etc.) have been performed for the face.

For example, the number (T1) of face feature vectors are built for a person, i.e. {ffv(1), ffv(2), . . . ffv(T1)}. As the person may keep very similar postures within the same person segment, a postprocessing step is taken to remove those similar feature vectors from the feature vector set. For example, if |ffv(i)-ffv(j)|<α where α is a small threshold, then the ith or jth feature vector will be removed. Hence, with this step, a final face feature vector set is obtained from the person segment for the person, i.e. {ffv(1), ffv(2), . . . ffv(t1)}(t1≦T1).

For extracting a gait feature vector, continuous frames that occur in conditions a) and b) in the person segment are looked for. Similarly, for extracting a voice feature vector, conditions c), d) and e) in the person segment are looked for. For example, if a person segment includes 1000 frames, and the person can be detected from the 20^{th} frame to 250^{th} frame, from the 350^{th} frame to 500^{th} frame and from the 700^{th} frame to 1000^{th} frame with the full human body detection. Then (please see also FIG. 5), three gait feature vectors can be built for the person from the part of the 20^{th} frame to 250^{th} frame, 350^{th} frame to 500^{th} frame and 700^{th} frame to 1000^{th} frame, i.e. {gfv(1), gfv(2), gfv(3)}. In this example, a post-processing step finds out that gfv(2) is very similar to gfv(3), whereby one of the vectors, either gfv(2) or gvc(3), can be removed. The resulting, i.e. final, gait feature vector set is then {gfv(1), gfv(2)} or {gfv(1), gfv(3)}.

The same methodology can be utilized for creating a voice feature vector set for the person.

Finally, a feature vector set can be created for the person, i.e. {{ffv1, . . . t1}{gfv1 . . . t2}{vfv1 . . . t3}}, where t1, t2, t3 are the number of feature vectors for face, gait and voice being extracted from the person segment of the person respectively.

### Method for Person Identification Model Creating or Updating

Compared to other features, e.g. gait and voice, a face feature may have much more reliable description for a person. Therefore, the highest priority can be imposed to the face feature vectors in people identification. In the identification model pool, a person model can be created or updated only if there are face feature vectors for the person ({ffv1 . . . t1}≠Ø). Otherwise, the input person feature vector set (which the face feature vector subset is null) can be only associated to relevant people registered already in the identification model pool.

In the following, two definitions for determining whether or not a person already has a registration in the identification model pool.

Definition 1: FIG. 5 illustrates two sets A and B, where A=(a1, a2, . . . , an) and B=(b1, b2, . . . bm). If the distance of one element aiεA and another element bjεB is smaller than a given threshold δ, i.e. |ai−bj≡<δ, set A is similar to the set B.

Definition 2: FIG. 5 illustrates sets A, B, C and D. If the set A has distances to the set B and set C smaller than the threshold δ. And if the distance between sets A and B is smaller than the distance between sets A and C. And set A has the distance to the set D bigger than the threshold δ. Then it is determined that set A is consistent with the set B, and associated to the set C, but unrelated to the set D. Therefore sets A and B can be merged because set B is the nearest to set A. Sets A and C can be associated, because their distance is smaller than the threshold. Sets A and D are unrelated because they are too far away from each other.

When a person feature vector is extracted from a video, e.g. {{ffv1 . . . t1}{gfv1 . . . t2}{vfv1 . . . t3}, the face feature vector subset {ffv1 . . . t1} is compared to all the face feature vector subsets {FFV(i, 1 . . . n1)}(i=1, 2, . . . , n) registered in the people identification model pool {i=1, 2, . . . , n|PM(i)={{FFV(i, 1 . . . n1)}{GFV(i, 1 . . . n2)}{VFV(i, 1 . . . n3)}}}, each PM(i) stands for a person registered in the model pool.

According to Definition 1, if the subset {ffv1 . . . t1} is not similar to any subset of {FFV(i, 1 . . . n1)}(i=1, 2, . . . , n), a new person registration is made in the identification model pool with the input person feature vector set {{ffv1 . . . t1}{gfv1 . . . t2}{vfv1 . . . t3}}, and there will then be n+1 registered people in the model pool.

Otherwise, according to Definition 2, all similar face feature subsets in the model pool are looked against the input face feature vector set, and the consistent subset and other associated subsets are confirmed if there are more than one similar face feature vector subsets from the model pool. Then, the person's data corresponding to the consistent face feature vector subset is updated in the identification model pool with the input person feature vector set. Also the person, who has been updated with the input data, is associated to the persons corresponding to the associated face feature vector subsets in the model pool.

For the updated person's data in the identification model pool, a fine-tuning step can be taken to avoid an input feature vector to update the person's data in the model pool if the person already has very similar feature vector in the model. For example, when the input person feature vector set {{ffv1 . . . t1}{gfv1 . . . t2}{vfv1 . . . t3}} is used to update the kth person in the identification model pool, PM(k)={{FFV(k, 1 . . . n1)}{GFV(k, 1 . . . n2)}{VFV(k, 1 . . . n3)}}, actually the person's three subsets are updated with corresponding three input subsets respectively, e.g. {ffv1 . . . t1} is used to update {FFV(k, 1 . . . n1), if {gfv1 . . . t2} and/or {vfv1 . . . t3} is null, {GFV(k, 1 . . . n2)} and/or {VFV(k, 1 . . . n3)} is not updated. And for every feature vector in {ffv1 . . . t1}, if there is at least one feature vector in {FFV(k, 1 . . . n1) that has a distance to the feature vector smaller than a given threshold fi, the feature vector will not join the update. The same methodology can be applied for person's gait and voice update.

If the input face feature vector set is null, i.e. {ffv1 . . . t1}=Ø, while there are only gait feature vectors and/or voice feature vectors in the input feature vector set, the process according to an embodiment goes as follows: First the input person feature vector set is directly saved in the identification model pool and it is checked whether the person can be associated to some other people already registered in the model pool based on their tagged location and time information etc.

For example, let us assume that the input feature vector set is {{gfv1 . . . t2}} (both {ffv1 . . . t1} and {vfv1 . . . t3} are null). All the people registered in the identification model pool is went through, and those people whose feature vectors have the same location information (e.g. feature vectors are extracted from the corresponding video captured at Great Trade area of Beijing) as that of the input feature vector set are picked up. It is noted that the feature vectors for a person registered in the model pool can have a different location and time tags, but all the feature vectors form the input feature vector set have the same location and time tags because they are extracted from the same input video. And further the similarity of the input gait feature vector set and the selected people's gait feature vector sets from the model pool is checked, and only such new person is associated to the people already registered in the model pool, who have similar gait feature vector sets to the input person feature vector set.

### Manual Correction on People Registration Results in the Identification Model Pool

Based on the automatic people model creating and updating solutions, a saved feature vector set or a person model may have one or several associated person models. This provides great cues to manually correct people registration in the model pool. For example, when a registered person is checked, the system provides all the associated people for a recommendation. If an associated person and the person who is being checked are the same person, the associated person's model can easily be merged into the person's model.

The various embodiments may provide advantages. For example, the solution builds a self-learning mechanism for creating an updating the identification model pool by inputting person feature vectors extracted from video data. The learning process is mimicking human vision system. The identification model pool can be easily applied for people identification on still images. In this case, only face feature vector sets in the pool are used.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-25. (canceled)

26. A method, comprising:
detecting a person segment in video frames;
extracting feature vector sets for several feature categories from the person segment;
generating a person feature model of the extracted feature vectors sets;
transmitting the person feature model to a people identification model pool.

27. The method of claim 26, wherein several feature categories relate to any combination of the following: face features, gait features, voice features, hand features, body features.

28. The method of claim 27, comprising at least one of:
extracting face feature vectors by locating a face from the person segment and estimating face's posture,
extracting gait feature vectors from a gait description map, that is generated by combining normalized silhouettes, which silhouettes are segmented from each frame of the person segment containing a full body of the person, and
determining voice feature vector by detecting person segment including person's close-up and detecting whether the person is speaking, and if so, the voice is extracted to determine the voice feature vector.

29. The method of the claim 26, wherein the person feature model is used to find a corresponding person feature model in the people identification model pool.

30. The method of claim 29, wherein if a corresponding person feature model is not found, the method comprises
creating a new person feature model to the people identification model pool.

31. The method of claim 29, wherein if a corresponding person feature model is found, the method comprises
updating the corresponding person feature model by the transmitted person feature model.

32. The method of the claim 26, wherein the person feature model is used to find an associating person feature model.

33. The method of claim 32, wherein the associating person feature model is found by determining either location information or time information or both of the person feature model and by finding an associating person feature model that matches with at least one of the information.

34. The method of claim 33, further comprising
merging the person feature model with the associating person feature model, if the models belong to the same person.

35. An apparatus comprising at least one processor, memory including computer program code, the memory and the computer program code configured to, with the at least one processor, cause the apparatus to perform at least the following:
detect a person segment in video frames;
extract feature vector sets for several feature categories from the person segment;
generate a person feature model of the extracted feature vectors sets; and
transmit the person feature model to a people identification model pool.

36. The apparatus of claim 35, wherein several feature categories relate to any combination of the following: face features, gait features, voice features, hand features, body features.

37. The apparatus of claim 36, wherein the memory and the computer program code configured to, with the at least one processor, are further being configured to at least one of:
cause the apparatus to extract face feature vectors by locating a face from the person segment and estimating face's posture,
cause the apparatus to extract gait feature vectors from a gait description map, that is generated by combining normalized silhouettes, which silhouettes are segmented from each frame of the person segment containing a full body of the person, and
determine voice feature vector by detecting person segment including person's close-up and detecting whether the person is speaking, and if so, the voice is extracted to determine the voice feature vector.

38. The apparatus of the claim 35, wherein the person feature model is used to find a corresponding person feature model in the people identification model pool.

39. The apparatus of claim 38, wherein if a corresponding person feature model is not found, the memory and the computer program code configured to, with the at least one processor, are further being configured to cause the apparatus to
create a new person feature model to the people identification model pool.

40. The apparatus of claim 38, wherein if a corresponding person feature model is found, wherein the memory and the computer program code configured to, with the at least one processor, are further being configured to cause the apparatus to
update the corresponding person feature model by the transmitted person feature model.

41. The apparatus of the claim 35, wherein the person feature model is used to find an associating person feature model.

42. The apparatus of claim 41, wherein the associating person feature model is found by determining either location information or time information or both of the person feature model and by finding an associating person feature model that matches with at least one of the information.

43. The apparatus of claim 42, wherein the memory and the computer program code configured to, with the at least one processor, are further being configured to cause the apparatus to merge the person feature model with the associating person feature model, if the models belong to the same person.

44. A system comprising at least one processor, memory including computer program code, the memory and the computer program code configured to, with the at least one processor, cause the system to perform at least the following:
detect a person segment in video frames;
extract feature vector sets for several feature categories from the person segment;
generate a person feature model of the extracted feature vectors sets; and
transmit the person feature model to a people identification model pool.
